(19) United States
(12) Patent Application Publication
(10) Pub. No.: US 2007/0264419 A1
(43) Pub. Date: Nov. 15, 2007

(54) COMPOSITION AND METHOD FOR TRANSLOCATION OF AROMATIC COMPOUNDS IN PLANTS

(76) Inventor: Virendra Kumar Tuli, Carson, CA (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 11/747,361

(22) Filed: May 11, 2007

Related U.S. Application Data
(60) Provisional application No. 60/747,085, filed on May 11, 2006.

(51) Int. Cl. A23L 1/222

(52) U.S. Cl. 426/651

(57) ABSTRACT

In accordance with various embodiments of the present invention, a composition and method configured for translocation of aromatic compounds in plants, e.g., synthesized or naturally-occurring aromatic compounds, are provided. For example, an exemplary chemical composition containing an aromatic compound is synthesized, absorbed through a plant's roots, translocated to the plant's roots, flowers, fruit, and/or leaves, whereby a flavor and/or aroma previously unassociated with the plant and/or fruit is emitted, or the pre-g existing flavor and/or aroma of the plant and/or fruit is enhanced. Additionally, an exemplary chemical composition optionally may contain ingredients other than aromatic compounds.

### CROSS-REFERENCE TO RELATED APPLICATIONS

This application claims priority to U.S. Provisional Patent Application Ser. No. 60/747,085, entitled “Composition and Method for Translocation of Aromatic Compounds in Plants,” filed May 11, 2006, which application, in its entirety, is hereby incorporated by reference herein.

### FIELD OF INVENTION

The present invention relates to plant nutrient systems, and in particular to a composition and method for translocation of aromatic compounds in plants.

### BACKGROUND OF THE INVENTION

A high phosphorous-to-nitrogen (P/N) ratio favors flowering and fruit development, whereas, a low P/N ratio favors vegetative growth. For this reason, it is common practice to cut down on nitrogen levels-through, for example, reduction in fertilizer application—at the onset of flowering in plants.

Unfortunately, this sudden deprivation of nitrogen often results in a metabolic imbalance caused by limited nitrogen availability. Crucial nitrogen-containing compounds such as amino acids, proteins, enzymes, nucleic acids, vitamins and hormones may not be synthesized fast enough to keep up with the metabolic demands of the plant.

Furthermore, the undesirable effects of nitrogen deprivation may be amplified under enriched carbon dioxide atmospheres and high light intensities. During flowering, many growers use high carbon dioxide concentrations, high temperatures, and light with longer wavelengths. Under such conditions, respiration can outstrip photosynthesis, thereby causing excessive ethylene production that results in senescence, yellowing of leaves, and leggy growth.

As such, what is needed in the art is a composition beneficial to plants during all phases of plant growth.

Furthermore, it would be an improvement in the art to have a composition capable of emitting and/or enhancing the flavor and/or aroma of a plant, its roots, flowers, fruit, and/or leaves.

### SUMMARY OF THE INVENTION

In accordance with various exemplary embodiments of the present invention, a composition and method configured for translocation of synthesized or naturally-occurring aromatic compounds in plants are provided. For example, an exemplary chemical composition containing an aromatic compound, such as a ketone, aldehyde or ester, is synthesized, absorbed through a plant's roots, translocated to the plant's roots, flowers, fruit, and/or leaves, whereby a flavor and/or aroma previously unassociated with the plant and/or fruit is emitted, or the preexisting flavor and/or aroma of the plant and/or fruit is enhanced. Additionally, an exemplary chemical composition optionally may contain ingredients such as carbohydrates, organic acids, vitamins, amino acids, polyphenolic compounds, secondary and trace elements, and may be solubilized in one or more liquid carriers.

### DETAILED DESCRIPTION

The following descriptions are of exemplary embodiments of the invention only, and are not intended to limit the scope or applicability of the invention in any way. Rather, the following description is intended to provide convenient illustrations for implementing various embodiments of the invention. As will become apparent, various changes may be made in the compositions described in these embodiments without departing from the spirit and scope of the invention.

In accordance with various exemplary embodiments of the present invention, a composition and method configured for translocation of synthesized or naturally-occurring aromatic compounds in plants are provided. Additionally, an exemplary chemical composition optionally may contain ingredients other than aromatic compounds, such as carbohydrates, organic acids, vitamins, amino acids, polyphenolic compounds, secondary and trace elements, and may be solubilized in one or more liquid carriers.

In some embodiments, the effect of the overall composition is additionally to prevent plants from becoming leggy and soft-stemmed in the presence of high nitrogen concentrations; to ensure a seamless and stress-free transition from the vegetative to the flowering stage even though nitrogen levels are artificially kept low; to protect plants from the metabolic imbalance between photosynthesis and respiration; and/or to help produce sturdy stems with short internodes and an abundance of buds, flowers and fruits.

Aromatic Compounds

In accordance with one aspect of an exemplary embodiment, a composition of the present invention comprises one or more aromatic compounds. Aromatic compounds as used herein comprise those chemical compounds, occurring naturally or synthesized, possessing or capable of possessing a flavor and/or aroma. Aromatic compounds act as flavor and/or aroma emitters or enhancers in plant products. Without being limited to any theory, it is believed that the aromatic compounds are absorbed through a plant's roots, translocated to the plant's roots, flowers, fruit, and/or leaves, whereby a flavor and/or aroma previously unassociated with the plant and/or fruit is emitted, or the preexisting flavor and/or aroma of the plant and/or fruit is enhanced. Examples of aromatic compounds within the spirit and scope of the invention include, but are not limited to ketones, aldehydes, esters, alcohols, amines and terpenes. Specifically, the present invention may include acetaldehyde, cinnamylaldehyde, isoeugenol, hydroxycitronellal and/or any other aromatic compound(s).

Examples of suitable aromatic compounds include, but are not limited to, 2,4,6-Trichloroanisole (cork taint); Anethole (liquorice, anise seed, ouzo, fennel); Anisole (anise seed); Eugenol (clove oil); Grapefruit mercaptan (grapefruit); Indole (jasmine flowery); Methyl salicylate (oil of wintergreen); Nerolin (orange flowers); Sotolon (maple syrup, curry, fenugreek).

Examples of suitable aldehydes include, but are not limited to, Acetaldehyde (pungent); Benzaldehyde (marzipan, almond); Hexanal (green, grassy); Cinnamaldehyde (cinnamon); cis-3-hexenal (green tomatoes); Citral (lemongrass, lemon oil); Neral (citrus, lemongrass); Vanillin (vanilla).

Examples of suitable esters include, but are not limited to, sec-Butyl acetate, Ethyl isobutyrate, Methyl 2-methylbutyrate, Methyl isovalerate, Isobutyl acetate, Ethyl butyrate, Propyl propionate, Butyl acetate, Methyl valerate, Isopropyl isobutyrate, Isopropyl butyrate, Ethyl isovalerate, Ethyl 2-methylbutyrate, Propyl isobutyrate, Isobutyl propionate, Amyl acetate, Isoamyl acetate, Propyl butyrate, Ethyl valerate, Butyl propionate, Isobutyl isobutyrate, Butyl isobutyrate, Isobutyl butyrate, Isoamyl propionate, Butyl butyrate, and Pentyl propionate.

Additional examples of suitable esters include, but are not limited to, Ethyl acetate (fruity, solvent); Ethyl butanoate—also known as ethyl butyrate (fruity); Methyl butanoate—also known as methyl butyrate (apple, fruity); Pentyl butanoate (pear, apricot); Pentyl pentanoate (apple, pineapple); Isoamyl acetate (banana); Hexyl acetate (apple, floral, fruity); Ethyl hexanoate—also known as ethyl caproate; Ethyl octanoate—also known as ethyl caprylate; Ethyl decanoate—also known as ethyl caprate; Strawberry aldehyde (strawberry).

Examples of suitable alcohols include, but are not limited to, Benzyl alcohol (oxidises to benzaldehyde, almond); cis-3-Hexen-1-ol (fresh cut grass); Ethyl maltol (sugary, cooked fruit); Furaneol (strawberry); Menthol (peppermint); 1-Hexanol (herbaceous, woody).

Examples of suitable amines include, but are not limited to, Substituted pyrazines: 2-ethoxy-3-isopropylpyrazine, 2-methoxy-3-sec-butylpyrazine, 2-methoxy-3-methylpyrazine (toasted seeds of fenugreek, cumin, and coriander).

Examples of suitable terpenes include, but are not limited to, Camphor (Cinnamomum camphora); Citronellol (rose); Linalool (floral, citrus, coriander); Nerol; Nerolidol; alpha-Terpineol; Thujone juniper, common sage, Nootka cypress, and wormwood); Thymol (Thyme-like).

While such components and steps may be realized by any number of compositions configured to perform the specified functions or provide the intended benefits of the aromatic compounds, in preferred embodiments, the composition comprises esters derived from natural sources. In accordance with an exemplary aspect of the present invention, the aromatic compound is not metabolized by the plant, and its chemical structure remains intact. The aromatic compound component will generally comprise from about 0.01% to 13% by weight of the composition herein, more preferably from about 5% to about 9% by weight, and most preferably about 7% by weight.

Carbohydrates

In accordance with another aspect of an exemplary embodiment, a composition of the present invention optionally comprises one or more carbohydrates. Carbohydrates are the end products of photosynthesis. Carbohydrates are broken down during respiration to release large amounts of chemical energy that are utilized by plants for biosynthetic reactions. Examples of carbohydrates within the spirit and scope of the invention include, but are not limited to fructose, glucose and sucrose. While such components and steps may be realized by any number of compositions configured to perform the specified functions or provide the intended benefits of the carbohydrates, in preferred embodiments, the composition comprises optimal concentrations of glucose, fructose and sucrose. However, it will be appreciated by one skilled in the art that any metabolically active compound may be used. The carbohydrate component will generally comprise from about 0.01% to 16% by weight of the composition herein, more preferably from about 8% to about 12% by weight, and most preferably about 10% by weight.

Organic Acids

In accordance with another aspect of an exemplary embodiment, a composition of the present invention optionally comprises one or more organic acids. Organic acids are formed during respiration as a consequence of the oxidation of pyruvic acid via the well-known Krebs cycle. Examples of organic acids within the spirit and scope of the invention include, but are not limited to pyruvic acid via the well-known Krebs cycle, citric acid, ascorbic acid, oxalic acid and alpha-ketoglutaric acid. While such components and steps may be realized by any number of compositions configured to perform the specified functions or provide the intended benefits of the organic acids, in preferred embodiments, the composition comprises citric acid and ascorbic acid (vitamin C). The organic acid component will generally comprise from about 0.01% to 13% by weight of the composition herein, more preferably from about 5% to about 9% by weight, and most preferably about 7% by weight.

Vitamins

In accordance with another aspect of an exemplary embodiment, a composition of the present invention optionally comprises one or more vitamins. Vitamins play a crucial role in plant development because they may function as co-factors for enzymes involved in carbohydrate metabolism and for enzymes involved in the biosynthesis of proteins and nucleic acids. Examples of vitamins within the spirit and scope of the invention include, but are not limited to thiamine, riboflavin, pyridoxine, niacin, calcium, pantothenic acid, and other suitable B-complex vitamins. While such components and steps may be realized by any number of compositions configured to perform the specified functions or provide the intended benefits of the vitamins, in preferred embodiments, the composition comprises significant amounts of thiamine, riboflavin, pyridoxine, niacin, and other B-complex vitamins obtained from fermented yeast extracts. However, it will be appreciated by one skilled in the art that any suitable vitamin, such as vitamin D and vitamin E, may be used. The vitamin component will generally comprise from about 0.01% to 7% by weight of the composition herein, more preferably from about 1% to about 3% by weight, and most preferably about 1% by weight.

Amino Acids

In accordance with another aspect of an exemplary embodiment, a composition of the present invention optionally comprises one or more amino acids. Amino acids are important plant nutrients because they serve as building blocks for proteins, including structural proteins and enzymes. In addition, amino acids are also involved in RNA and DNA synthesis. While such components and steps may be realized by any number of compositions configured to perform the specified functions or provide the intended benefits of the amino acids, in preferred embodiments, the composition comprises the following amino acids: glycine, alanine, valine, leucine, isoleucine, serine, threonine, aspartic acid, glutamic acid, asparagine, glutamine, lysine, arginine, histidine, cysteine, cystine, methionine, proline, phenylalanine, tyrosine, and tryptophan. The amino acid component will generally comprise from about 0.01% to 17% by weight of the composition herein, more preferably from about 9% to about 13% by weight, and most preferably about 11% by weight.

Polyphenolic Compounds

In accordance with another aspect of an exemplary embodiment, a composition of the present invention optionally comprises one or more polyphenolic compounds. Polyphenolic compounds act as natural antioxidants, and assist in slowing down the aging process, providing more vigorous growth and a healthier plant. Polyphenolic compounds also work synergistically with aromatic compounds to enhance flavors and aromas. Examples of polyphenolic compounds within the spirit and scope of the invention include, but are not limited to compounds derived from humic acid and fulvic acid. However, such components and steps may be realized by any number of compositions configured to perform the specified functions or provide the intended benefits of the polyphenolic compounds. The polyphenolic compound component will generally comprise from about 0.01% to 8% by weight of the composition herein, more preferably from about 1% to about 4% by weight, and most preferably about 2% by weight of the composition.

Secondary/Trace Elements

In accordance with another aspect of an exemplary embodiment, a composition of the present invention optionally comprises one or more secondary and/or trace elements. Secondary and trace elements are obligatory co-factors for some of the enzymes involved in photosynthesis and respiration. While such components and steps may be realized by any number of compositions configured to perform the specified functions or provide the intended benefits of the secondary and trace elements, in preferred embodiments, the composition comprises magnesium, sulfur, iron, boron, manganese, zinc, copper and molybdenum. Preferably, the secondary and trace element component will comprise no greater than from about 0.1% to 7% by weight of the composition herein.

### EXAMPLES

One exemplary embodiment of the composition for translocation of aromatic compounds in plants herein described is shown in Table 1. The weight percents shown in Table 1 are without a liquid carrier.

TABLE 1

| | | | Qty | Wt |
|---|---|---|---|---|
| Part # | Component | Name | (g) | (%) |
| 1 | Flavors, Aromas | Aldehydes, Esters | 2.0 | 6.7 |
| 2 | Carbohydrates | Cane sugar | 3.0 | 10.0 |
| 3 | Organic acids | Citric acid | 1.0 | 3.3 |
| 4 | | Ascorbic acid (vitamin C) | 1.0 | 3.3 |
| 5 | Vitamins | Thiamine | 0.15 | 0.5 |
| 6 | | Riboflavin | 0.1 | 0.3 |
| 7 | | Pyridoxine | 0.1 | 0.3 |
| 8 | | Niacin | 0.1 | 0.3 |
| 9 | Amino acids | Glycine | 0.15 | 0.5 |
| 10 | | Alanine | 0.15 | 0.5 |
| 11 | | Valine | 0.15 | 0.5 |
| 12 | | Leucine | 0.15 | 0.5 |
| 13 | | Isoleucine | 0.15 | 0.5 |
| 14 | | Serine | 0.15 | 0.5 |
| 15 | | Threonine | 0.15 | 0.5 |
| 16 | | Aspartic acid | 0.15 | 0.5 |
| 17 | | Glutamic acid | 0.15 | 0.5 |
| 18 | | Asparagine | 0.15 | 0.5 |
| 19 | | Glutamine | 0.15 | 0.5 |
| 20 | | Lysine | 0.15 | 0.5 |
| 21 | | Arginine | 0.15 | 0.5 |
| 22 | | Histidine | 0.15 | 0.5 |
| 23 | | Cysteine | 0.15 | 0.5 |
| 24 | | Cystine | 0.15 | 0.5 |
| 25 | | Methionine | 0.15 | 0.5 |
| 26 | | Proline | 0.15 | 0.5 |
| 27 | | Phenylalanine | 0.15 | 0.5 |
| 28 | | Tyrosine | 0.15 | 0.5 |
| 29 | | Tryptophan | 0.15 | 0.5 |
| 30 | Major, secondary | Epsom salt | 8.0 | 26.7 |
| 31 | and trace | Potassium phosphate | 6.0 | 20.0 |
| 32 | elements | Ferrous sulfate | 0.5 | 1.7 |
| 33 | | Calcium sulfate | 4.0 | 13.3 |
| 34 | | Micronutrient compound | 0.4 | 1.3 |
| | | (e.g., magnesium, sulfur, | | |
| | | iron, boron, manganese, | | |
| | | zinc, copper | | |
| | | and/or molybdenum) | | |
| 35 | Polyphenolics | Fulvic, Humic | 0.5 | 1.7 |

| | | | | |
|---|---|---|---|---|
| — | Total | 30 | g | 100% |

Liquid Carrier

In accordance with one aspect of an exemplary embodiment of the present invention, a composition formulated in accordance with the disclosure hereinabove is solubilized in one or more liquid carriers. A liquid carrier as used herein may be any component capable of solubilizing the other ingredients of the composition. Examples of liquid carriers within the spirit and scope of the invention include, but are not limited to, water and any alcohol. However, such components and steps may be realized by any number of compositions configured to perform the specified functions or provide the intended benefits of the liquid carriers. The liquid carrier component will generally comprise from about 60% to 90% by weight of the solubilized composition herein, and more preferably from about 70% to about 80% by weight of the solubilized composition.

In accordance with an exemplary embodiment of the present invention, when solubilized, the flavors, aromas, carbohydrates, organic acids, vitamins, amino acids, polyphenolic compounds, and secondary and trace elements generally comprise from about 5% to 50% by weight of the solubilized composition herein, and more preferably from about 10% to about 30% by weight of the solubilized composition. This however should not be construed as limiting the weight percent of any component(s) of the invention.

In an exemplary embodiment, the composition shown in Table 1 is mixed with 100 ml of one or more liquid carriers, such that the liquid carrier component comprises about 70% by weight of the solubilized composition. However, skilled artisans will appreciate that the liquid carrier component may comprise any percent of the composition appropriate for the plant phase or to effectively emit and/or enhance the flavor and/or aroma of a plant, its roots, flowers, fruit, and/or leaves. In other exemplary embodiments, a liquid carrier is not necessary.

Turning to a method for translocation of aromatic compounds in plants to thereby emit and/or enhance the flavor and/or aroma of a plant, its roots, flowers, fruit, and/or leaves, the composition described herein may be applied to a plant (i.e., direct application) and/or surrounding area (i.e., indirect application), or solubilized, diluted with water and then applied thereto. In an exemplary embodiment, the solubilized composition is diluted to about 0.02% to about 1.0% by volume and more preferably to about 0.2% to about 0.6% by volume, for example, by combining with standard watering regimes. Application may be accomplished using any number of conventional systems (e.g., sprayers, water cans, nozzles, irrigation systems, hydroponic systems, etc.) or application systems or methods hereinafter developed. For example, if a user were to water a series of garden plants with a one gallon watering can, the user would simply add 10-30 ml of the solubilized composition thereto and water as normal. Additional exemplary embodiments of a method for translocation of aromatic compounds in plants using the exemplary composition above are shown in Table 2.

TABLE 2
Exemplary Application Rates

| | Solubilized composition for | |
|---|---|---|
| | translocation of aromatic | |
| Phase | compounds in plants | Water |
| Vegetative Phase | 10 ml | 3.78 L (1 Gal) |
| Transition Phase | 10–15 ml | 3.78 L (1 Gal) |
| Fruiting and | 15–20 ml | 3.78 L (1 Gal) |
| Flowering/Reproductive | | |
| Phase | | |

The present invention has been described above with reference to various exemplary embodiments. However, those skilled in the art will recognize that changes and modifications may be made to the exemplary embodiments without departing from the scope of the present invention. For example, the various processing steps, as well as the components, compositions and mixtures for carrying out the processing steps, may be implemented in alternate ways depending upon the particular application or in consideration of any number of cost functions associated with the intended uses of the composition, e.g., various of the compositions, components and methodologies and/or steps may be deleted, modified, or combined with other components, methodologies and/or steps. For example, the application rates illustrated for the vegetative, transition and fruiting phases may be suitably modified, for example, cut in half or less, or doubled or more.

These and other changes or modifications are intended to be included within the scope of the present invention.

1. A composition for translocation of aromatic compounds in a plant comprising:
at least one aromatic compound, which aromatic compound is characterized by a flavor and/or an aroma;
at least one carbohydrate;
at least one organic acid;
at least one vitamin;
at least one amino acid; and
at least one polyphenolic compound,
wherein said flavor and/or aroma is emitted by and/or enhanced within said plant.

2. The composition of claim 1, wherein the composition is solubilized in a liquid carrier.

3. The composition of claim 2, wherein said liquid carrier is present in an amount from about 60% to about 90% by weight of the solubilized composition.

4. The composition of claim 1, wherein said at least one aromatic compound is present in an amount from about 0.01% to 13% by weight of the solubilized composition.

5. The composition of claim 1, wherein said at least one carbohydrate is present in an amount from about 0.01% to 16% by weight of the solubilized composition.

6. The composition of claim 1, wherein said at least one organic acid is present in an amount from about 0.01% to 13% by weight of the solubilized composition.

7. The composition of claim 1, wherein said at least one vitamin is present in an amount from about 0.01% to 7% by weight of the solubilized composition.

8. The composition of claim 1, wherein said at least one amino acid is present in an amount from about 0.01% to 17% by weight of the solubilized composition.

9. The composition of claim 1, wherein said at least one polyphenolic compound is present in an amount from about 0.01% to 8% by weight of the solubilized composition.

10. The composition of claim 1, further comprising one or more secondary and/or trace element(s), wherein said secondary and/or trace element(s) is/are present in an amount from about 0.1% to 7% by weight of the solubilized composition.

11. A method for translocation of aromatic compounds in a plant comprising:
providing a composition comprising:
at least one aromatic compound, which aromatic compound is characterized by a flavor and/or an aroma;
at least one carbohydrate;
at least one organic acid;
at least one vitamin;
at least one amino acid;
at least one polyphenolic compound;
optionally, at least one secondary and/or trace element(s); and
solubilizing said composition in a liquid carrier to yield a solubilized composition;
applying an amount of said solubilized composition directly or indirectly to said plant, wherein said flavor and/or aroma is emitted by and/or enhanced within said plant.

12. The method of claim 11 wherein said step of applying an amount of said solubilized composition directly or indirectly to said plant comprises applying an amount of said solubilized composition directly or indirectly to said plant during the transition phase and an amount of said solubilized composition directly or indirectly to said plant during the vegetative phase, wherein the amount of said composition applied to said plant during the transition phase is greater than the amount of said composition applied to said plant during the vegetative phase.

13. The method of claim 11 wherein said step of applying an amount of said solubilized composition directly or indirectly to said plant comprises applying an amount of said solubilized composition directly or indirectly to said plant during the fruiting and flowering/reproductive phase and an amount of said solubilized composition directly or indirectly to said plant during the transition phase, wherein the amount of said composition applied to said plant during the fruiting and flowering/reproductive phase is greater than the amount of said composition applied to said plant during the transition phase.

14. The method of claim 11, further comprising diluting said solubilized composition with water to form a diluted composition prior to said applying step.

15. The method of claim 14, wherein said diluting step comprises diluting said solubilized composition to about 0.02% to about 1.0% by volume of the diluted composition.
